(19) United States
(12) Patent Application Publication
(10) Pub. No.: US 2025/0142168 A1
(43) Pub. Date: May 1, 2025

(54) AUTOMATIC DETECTION OF LANGUAGE PREFERENCE IN A MEDIA PRESENTATION SYSTEM

(71) Applicant: DISH Network Technologies India Private Limited, Bengaluru (IN)

(72) Inventors: Vikram Balaraja Shetty, Bengaluru (IN); Manasa Jami, Andhra Pradesh (IN); Dileep Puramana, Kerala (IN); Visali Manoharan, Tamil Nadu (IN)

(21) Appl. No.: 18/384,551

(22) Filed: Oct. 27, 2023

(51) Int. Cl. H04N 21/454; G06V 40/12; G06V 40/16; G10L 17/00

(52) U.S. Cl. CPC H04N 21/454; G06V 40/12; G06V 40/173; G10L 17/00

(57) ABSTRACT

Various embodiments electronically determine whether a particular user of a plurality of users is viewing or listening to a presentation device (e.g., a TV), such as by biometric identification of the user via a remote control device or other device. The system then automatically detects which language is preferred by the particular user in response to the electronic determination whether the particular user is viewing or listening to the presentation device, such as indicated in a user profile associated with the biometric identification of the user. Based on the automatic detection of which language is preferred by the user, the system electronically presents media to the user that is in the detected language.

### TECHNICAL FIELD

The technical field relates to electronically presenting media and more particularly, to apparatus, systems and methods for providing automatic detection of language preference in a media presentation system.

### BRIEF SUMMARY

Systems and methods for automatic detection of language preference in a media presentation system are provided. It is often desirable to change the language on a receiving device (e.g., a satellite or cable set-top box) or presentation device, such as a television (TV), based on a customer's language preference in order to provide a better viewing experience for the customer. This may mean changing the language of the set-top box or TV user interface, the electronic program guide (EPG), as well as selecting sub-titles (i.e., audio captions), audio tracks, recommendations for content, channels and programming that are in a particular language.

However, it is often difficult and inconvenient to find such settings, channels and programming for a particular language, especially when using an unfamiliar television or set-top box, such as when traveling and staying in hotels or other temporary accommodations. Also, such settings may need to be frequently changed in a residential environment where there could be multiple users who watch TV, as the language settings preferences as well as the recommendation content may vary from user to user. Environments in which a particular television may be watched by multiple different individuals at different times (e.g., senior living centers or group homes) may also have a need to frequently switch between language setting preferences for those individuals to watch TV content according to their language preferences.

To solve this technical problem, the systems and methods described herein electronically determine whether a particular user of a plurality of users is viewing or listening to a presentation device (e.g., a TV), such as by biometric (e.g., thumbprint) identification of the user via a remote control device or other device. The system then automatically detects which language is preferred by the particular user in response to the electronic determination whether the particular user is viewing or listening to the presentation device, such as indicated in a stored user profile associated with the biometric identification of the user. Based on the automatic detection of which language is preferred by the user, the system electronically presents media to the user that is in the detected language.

For example, electronically presenting media to the user that is in the detected language may include one or more of: automatically selecting language preference settings available in a configuration menu of the presentation device or receiving device connected to the presentation device based on the detected language; automatically switching to a user interface on the presentation device that is in the detected language; automatically switching to an audio track of a program being displayed on the presentation device that is in the detected language; automatically switching to present on the presentation device audio captions that are in the detected language for a program currently being displayed on the presentation device; automatically presenting on the presentation device a selectable list that only includes one or more television channels that is in the detected language or other content that are in the detected language; automatically presenting on the presentation device a selectable list of recommendations of content that is in the detected language; and automatically selecting and presenting on the presentation device content of one or more television channels that are in the detected language.

In some embodiments, a particular user is determined to be viewing or listening to the presentation device based on a particular time window assigned to or otherwise associated with that user or the user's preferred language.

### BRIEF DESCRIPTION OF THE DRAWINGS

The components in the drawings are not necessarily to scale relative to each other. Like reference numerals designate corresponding parts throughout the several views.

FIG. 1 is a block diagram illustrating an example communication system in which embodiments of systems and methods for automatic detection of language preference in a media presentation system may be implemented.

FIG. 2 is a block diagram illustrating example functional elements of an example embodiment.

FIGS. 3A, 3B and 3C are diagrams of example user interfaces provided by example embodiments.

FIG. 4 is a block diagram of a computing system for practicing example embodiments of systems and methods for automatic detection of language preference in a media presentation system for automatic detection of language preference in a media presentation system.

FIG. 5 is a flow diagram of a method for presenting media based on automatic detection of which language is preferred, according to an example embodiment.

FIG. 6 is a flow diagram of a method for presenting media based on a language preference saved in a database accessible by a computerized management system of a multi-unit property, according to an example embodiment.

FIG. 7 is a flow diagram of a method for determining that a particular user having a particular language preference is viewing or listening to the presentation device based on time windows.

### DETAILED DESCRIPTION

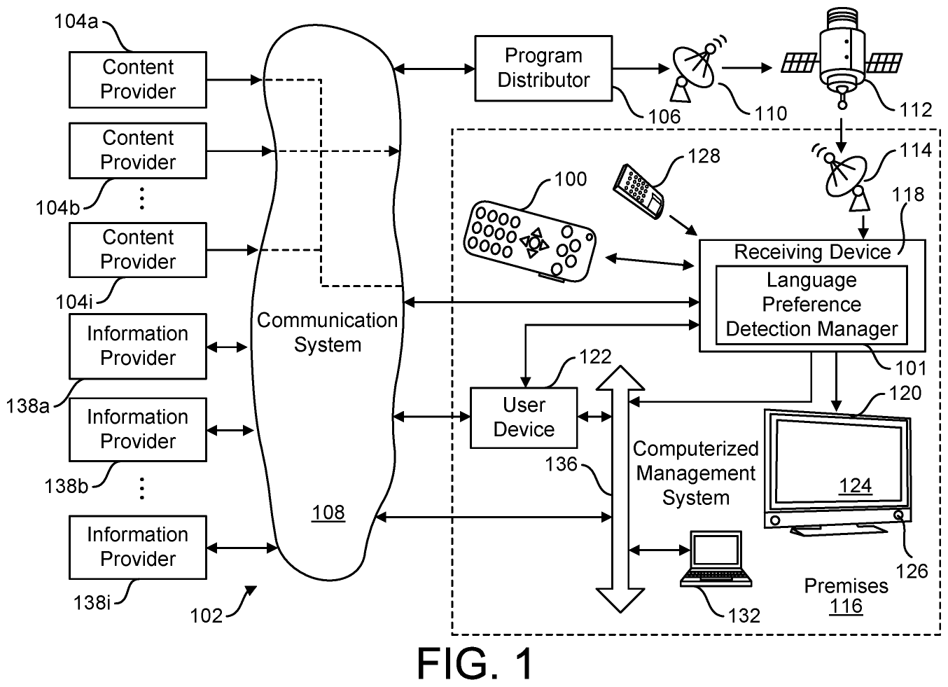

FIG. 1 is a block diagram illustrating an example communication system in which embodiments of systems and methods for automatic detection of language preference in a media presentation system may be implemented. It is to be appreciated that FIG. 1 illustrates just one example of a networked environment 102 and that the various embodiments discussed herein are not limited to such systems. Networked environment 102 can include a variety of communication systems and can use a variety of communication media including, but not limited to, satellite wireless media.

Audio, video, and/or data service providers, such as, but not limited to, television service providers, provide their customers a multitude of audio/video and/or data programming (hereafter, collectively and/or exclusively “programming”). Such programming is often provided by use of a receiving device 118 communicatively coupled to a presentation device 120 configured to receive the programming.

Receiving device 118 interconnects to one or more communications media or sources (such as a cable head-end, satellite antenna, telephone company switch, Ethernet portal, off-air antenna, or the like) that provide the programming. The receiving device 118 commonly receives a plurality of programming by way of the communications media or sources described in greater detail below. Based upon selection by the user, the receiving device 118 processes and communicates the selected programming to the one or more presentation devices 120.

For convenience, the receiving device 118 may be interchangeably referred to as a “television converter,” “receiver,” “set-top box,” “television receiving device,” “television receiver,” “television recording device,” “satellite set-top box,” “satellite receiver,” “cable set-top box,” “cable receiver,” “media player,” “smartphone”, “device” and/or “television tuner”. Accordingly, the receiving device 118 may be any suitable converter device or electronic equipment that is operable to receive and/or play programming. Further, the receiving device 118 may itself include user interface devices, such as buttons or switches. In many applications, a remote-control device 128 is operable to control the presentation device 120 and other user devices 122.

Examples of a presentation device 120 include, but are not limited to, a television (“TV”), a personal computer (“PC”), a digital video recorder (“DVR”), a smartphone, a tablet device, a wireless device, a user device, game system, or the like. Presentation devices 120 employ a display 124, one or more speakers, and/or other output devices to communicate video and/or audio content to a user. In many implementations, one or more presentation devices 120 reside in or near a premises 116 (e.g., a premises, a multi-unit property, a hotel room, a senior living center, a venue, a commercial or business premises, etc.) and are communicatively coupled, directly or indirectly, to the receiving device 118. Further, the receiving device 118 and the presentation device 120 may be integrated into a single device. Such a single device may have the above-described functionality of the receiving device 118 and the presentation device 120, or may even have additional functionality.

A plurality of content providers 104a-104i provide program content, such as television or streaming content or audio content, to a distributor, such as the program distributor 106. Example content providers 104a-104i include television stations which provide local or national television programming or streaming content, special content providers which provide premium based programming or pay-per-view programming, steaming content providers, or radio stations which provide audio programming.

Program content, interchangeably referred to as a program, is communicated to the program distributor 106 from the content providers 104a-104i through suitable communication media, generally illustrated as communication system 108 for convenience. Communication system 108 may include many different types of communication media, now known or later developed. Non-limiting media examples include telephony systems, the Internet, internets, intranets, cable systems, fiber optic systems, microwave systems, asynchronous transfer mode (“ATM”) systems, frame relay systems, radio frequency (“RF”) systems, and satellite systems. Further, program content communicated from the content providers 104a-104i to the program distributor 106 may be communicated over combinations of media. For example, a television broadcast station may initially communicate program content, via an RF signal or other suitable medium, that is received and then converted into a digital signal suitable for transmission to the program distributor 106 over a fiber optic system. As another non-limiting example, an audio content provider may communicate audio content via its own satellite system to the program distributor 106.

In at least one embodiment, the received program content is converted by one or more devices (not shown) as necessary at the program distributor 106 into a suitable signal that is communicated (i.e., “uplinked”) by one or more antennae 110 to one or more satellites 112 (separately illustrated herein from, although considered part of, the communication system 108). It is to be appreciated that the communicated uplink signal may contain a plurality of multiplexed programs. The uplink signal is received by the satellite 112 and then communicated (i.e., “downlinked”) from the satellite 112 in one or more directions, for example, onto a predefined portion of the planet. It is appreciated that the format of the above-described signals are adapted as necessary during the various stages of communication.

A receiver antenna 114 that is within reception range of the downlink signal communicated from satellite 112 receives the above-described downlink signal. A wide variety of receiver antennae 114 are available. Some types of receiver antenna 114 are operable to receive signals from a single satellite 112. Other types of receiver antenna 114 are operable to receive signals from multiple satellites 112 and/or from terrestrial based transmitters.

The receiver antenna 114 can be located at premises 116. Examples of premises 116 include a residence, a business, a multi-unit property, a hotel, a hotel room, a senior living center, a venue, a commercial or business premises, or any other suitable location operable to receive signals from satellite 112. The received signal is communicated, typically over a hard-wire connection, to a receiving device 118. The receiving device 118 may be a conversion device that converts, also referred to as formatting, the received signal from antenna 114 into a signal suitable for communication to a presentation device 120 and/or a user device 122. Often, the receiver antenna 114 is of a parabolic shape that may be mounted on the side or roof of a structure. Other antenna configurations can include, but are not limited to, phased arrays, wands, or other dishes. In some embodiments, the receiver antenna 114 may be remotely located from the premises 116. For example, the antenna 114 may be located on the roof of an apartment building, such that the received signals may be transmitted, after possible recoding, via cable or other mechanisms, such as WiFi, to the premises 116.

The received signal communicated from the receiver antenna 114 to the receiving device 118 is a relatively weak signal that is amplified, and processed or formatted, by the receiving device 118. The amplified and processed signal is then communicated from the receiving device 118 to a presentation device 120 in a suitable format, such as a television (“TV”) or the like, and/or to a user device 122. It is to be appreciated that presentation device 120 may be any suitable device operable to present a program having video information and/or audio information.

User device 122 may be any suitable device (e.g., smartphone, tablet device, notebook computer or other mobile device) that is operable to receive a signal from the receiving device 118, another endpoint device, or from other devices external to the premises 116, such as via a cellular signal and/or the Internet via communication system 108. Additional non-limiting examples of user device 122 include optical media recorders, such, a digital versatile disc or digital video disc (“DVD”) recorder, a digital video recorder (“DVR”), or a personal video recorder (“PVR”). User device 122 may also include game devices, RF transceivers, and personal computers (“PCs”).

An interface between the receiving device 118 and a user (not shown) may be provided by a hand-held remote-control device (“remote”) 128. Remote 128 typically communicates with the receiving device 118 using a suitable wireless medium, such as infrared (“IR”), RF, or the like. Other devices (not shown) may also be communicatively coupled to the receiving device 118 so as to provide user input and instructions to the receiving device 118. Non-limiting examples include game device controllers, keyboards, pointing devices, and the like.

The receiving device 118 may receive programming partially from, or entirely from, another source other than the above-described receiver antenna 114, such as streaming media sources via the Internet. Other embodiments of the receiving device 118 may receive locally broadcast RF signals, or may be coupled to communication system 108 via any suitable medium. Non-limiting examples of medium communicatively coupling the receiving device 118 to communication system 108 include cable, fiber optic, or Internet media.

Premises 116 may include other devices which are communicatively coupled to communication system 108 via a suitable media. For example, but not limited to, some premises 116 include an optional network 136, or a networked system, to which receiving devices 118, presentation devices 120, and/or a variety of user devices 122 can be coupled, collectively referred to as endpoint devices. For example, such a network may be that of a hotel or multi-unit property to which respective presentation devices and/or receiving devices in various rooms or units are connects and over which information (e.g., language preferences and other preferences and settings for the respective presentation devices and/or receiving devices) is communicated between a computerized management system 132 and the respective presentation devices and/or receiving devices in various rooms or units. Non-limiting examples of network 136 include, but are not limited to, an Ethernet, twisted pair Ethernet, an intranet, a local area network (“LAN”) system, a WiFi network or the like. One or more endpoint devices, such as PCs, data storage devices, TVs, game systems, sound system receivers, Internet connection devices, wireless LAN, WiFi, Worldwide Interoperability for Microwave Access (“WiMax”), or the like, are communicatively coupled to network 136 so that the plurality of endpoint devices are communicatively coupled together. Thus, the network 136 may enable the interconnected endpoint devices (e.g., respective presentation devices and/or receiving devices in various rooms or units) and the receiving device 118, to communicate with each other and the computerized management system 132. Alternatively, or in addition, some devices in the premises 116 may be directly connected to the communication system 108, such as the computerized management system 132, which may employ a hardwire connection or an RF signal for coupling to communication system 108. In some embodiments, devices shown in FIG. 1, such as user device 122, computerized management system 132, remote 128 and thumbprint enabled remote-control device 100 may be operably coupled to the receiving device 118 via a short range wireless or point-to-point connections, such a Bluetooth® connection.

A plurality of information providers 138a-138i are coupled to communication system 108. Information providers 138a-138i may provide various forms of content and/or services to the various devices residing in the premises 116. For example, information provider 138a may provide requested information of interest to receiving device 118, presentation device 120, computerized management system 132 and/or user device 122. Information providers 138a-138i may further provide language information, electronic program guide (EPG) information and other metadata indicative of which language particular programming or channels are in.

In an example embodiment, the system for automatic detection of language preference in a media presentation system includes a thumbprint enabled remote-control device 100 (or other biometric data-enabled remote control or other device) and a language preference detection manager 101 operating upon the receiving device 118 and/or presentation device 120. The language preference detection manager 101 receives unique biometric identification data from the remote-control device 100 which the language preference detection manager 101 may use to determine whether a particular user of a plurality of users is viewing or listening to presentation device 120. In various embodiments, the user may have previously registered their thumbprint or other biometric identification data (e.g., photograph for facial recognition, voice for voice recognition, etc.) with the language preference detection manager 101 via the remote control device 100, user device 122, receiving device 118 or other biometric data-enabled device that may communicate with the language preference detection manager 101. Thus, in various embodiments, the remote control device 100, user device 122, receiving device 118 or other biometric data-enabled device in networked environment 102 may have one or more fingerprint scanners or readers, microphones and associated voice detection functionalities, cameras and associated facial recognition functionalities, other biometric scanners and associated biometric identification functionalities.

In some embodiments, the user may have registered their language preference (e.g., upon check-in or visiting their room in a hotel comprising premises 116) in a unique user profile stored in or accessible by the language preference detection manager 101 and/or the computerized management system 132, which may manage multiple presentation devices, such as when the premises 116 is a multi-unit property such as a hotel. In such instances, the user may be determined to be viewing or listening to a particular presentation device on premises 116 based on the user checking in to a particular room on premises 116 associated with that particular presentation device and/or being identified via remote control device 100 that is associated with a particular presentation device. Such registration of the user's language preference may be made via the presentation device 120, remote control device 100 an/or user device 122.

The language preference detection manager 101 and/or the computerized management system 132 then automatically detects which language of a plurality of different languages is preferred by the particular user in response to the electronic determination whether the particular user is viewing or listening to the presentation device 120. For example, this may be based on a language preference indicated by the user profile associated with the unique biometric identification data or other identification data provided by the user or a device of the user. In various embodiments, the user profile may be stored in the remote-control device 100, the language preference detection manager 101 of the receiving device 118, the user device 122, the presentation device 120, the computerized management system 132 and/or a remote system accessible by the language preference detection manager 101 via communication system 108.

Based on the automatic detection of which language of a plurality of languages is preferred by the user, the language preference detection manager 101 and/or computerized management system 132 (which may manage multiple different presentation devices on premises 116) may cause media that is in the detected language to be presented to the user via the presentation device 120. In various embodiments, instructions, settings or commands communicated from the language preference detection manager 101 and/or computerized management system 132 for causing media that is in the detected language to be presented to the user may be communicated directly to presentation device 120, communicated via optional network 136 and/or communicated via communication system 108. In various embodiments, the language preference detection manager 101 may be located in the receiving device 118, the remote-control device 100, the user device 122, the presentation device 120, the computerized management system 132 and/or a remote system accessible via communication system 108 and/or optional network 136.

The system for automatic detection of language preference in a media presentation system may use the detected language to control the receiving device 118. For example, if the detected language preference is French, the receiving device 118 may cause the presentation device to switch user interface and/or electronic program guide (EPG) to be in French. In other embodiments, the receiving device 118 may electronically select one or more television channels of the program distributor 106 that are in French. The receiving device 118 may then automatically present (e.g., as a pop-up menu) on the display 124 a selectable list those television channels that are in French (e.g., are broadcast in French, have French audio tracks, that are from French television stations, include French programs and/or are otherwise associated with the French language). As another example, if the detected language preference is French, the receiving device 118 may automatically switch to a French television channel, or, the next time the user presses a button on the remote 128 or thumbprint enabled remote-control device 100 to bring up an electronic program guide (EPG), the receiving device 118 may instead present a customized French EPG that includes a selectable list of French channels (e.g., channels that are in French) first before other channels that are not in French.

In other embodiments, the system for automatic detection of language preference in a media presentation system may include additional components or be structured in other ways. For example, functions of the language preference detection manager 101 may be distributed between the receiving device 118 and the thumbprint enabled remote-control device 100. As another example, the language preference detection manager 101 or similar component may operate upon (e.g., execute in) other media devices, including the presentation device 120, the user device 122, and the like. Furthermore, the language preference detection manager 101, situated within a first device (such as the receiving device 118), can be configured to control other, remote media devices, such as the user device 122, presentation device 120, and the like.

The system for automatic detection of language preference in a media presentation system provides numerous advantages. For example, such a system may be used in hotel rooms that often receive international travelers. The user would be able to immediately enjoy programming in a language they understand by merely checking in to their hotel room (via the computerized management system 132 accessing the user's pre-registered language preference in their user profile), without the user having to view each channel to search for programs in their own language or search the program guide that is unfamiliar and perhaps in a different language than the user understands.

The above description of the communication system 102 and the premises 116, and the various devices therein, is intended as a broad, non-limiting overview of an example environment in which various embodiments of a system for automatic detection of language preference in a media presentation system may be implemented. The communication system 102 and the various devices therein, may contain other devices, systems and/or media not specifically described herein.

Example embodiments described herein provide applications, tools, data structures and other support to implement a system for automatic detection of language preference in a media presentation system. Other embodiments of the described techniques may be used for other purposes, including for interaction with, and control of, remote systems generally. In the following description, numerous specific details are set forth, such as data formats, code sequences, and the like, in order to provide a thorough understanding of the described techniques. The embodiments described also can be practiced without some of the specific details described herein, or with other specific details, such as changes with respect to the ordering of the code flow, different code flows, and the like. Thus, the scope of the techniques and/or functions described are not limited by the particular order, selection, or decomposition of steps described with reference to any particular module, component, or routine.

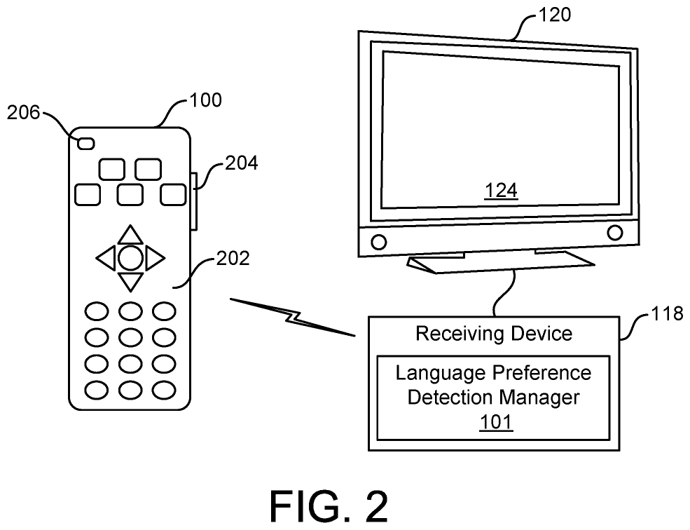

FIG. 2 is a block diagram illustrating example functional elements of an example embodiment. In the example of FIG. 2, the system for automatic detection of language preference in a media presentation system includes a receiving device 118, a thumbprint enabled remote-control device 100, and a presentation device 120.

A language preference detection manager 101 is executing on the receiving device 118, which is a set-top box in this particular example. The receiving device 118 is communicatively coupled to the presentation device 120. As noted, the receiving device 118 may be communicatively coupled to other media devices, such as a video recorder or audio system, so as to control those media devices based on the detected language preference of the user 220.

The receiving device 118 is also wirelessly communicatively coupled to the thumbprint enabled remote-control device 100. In the illustrated embodiment, the receiving device 118 and thumbprint enabled remote-control device 100 communicate using radio frequency (e.g., UHF) transmissions. In other embodiments, other communication techniques/spectra may be utilized, such as infrared (“IR”), microwave, short range wireless connections (e.g., Bluetooth® connections) or the like. The remote-control device 100 includes a keypad 202 having multiple buttons (keys), an optional language preference detection key 204, and a thumbprint scanner 206. The keypad 202 includes multiple keys that are each associated with a particular command that can be generated by the thumbprint enabled remote-control device 100 and transmitted to the receiving device 118.

The thumbprint scanner 206 captures the user's thumbprint for identification. In an example embodiment, this identification may be associated with a user profile stored in the remote-control device 100, the language preference detection manager 101 of the receiving device 118, the user device 122, the presentation device 120, the computerized management system 132 and/or a remote system accessible via communication system 108. In response to the user using the thumbprint scanner 206 on the remote-control device 100, the remote-control device 100 may transmit the thumbprint identification data to the language preference detection manager 101. The language preference detection manager 101 may then determine which particular user of a plurality of users is viewing or listening to the presentation device 120 by retrieving a user profile that is associated with the unique thumbprint identification data. The language preference detection manager 101 may determine that the particular user associated with the retrieved user profile is viewing or listening to the presentation device 120. The user profile may indicate a language preference of the user. The language preference detection manager 101 may then detect that the particular user prefers the language preference indicated in the user profile associated with that user in response to determining that the particular user associated with the retrieved user profile is viewing or listening to the presentation device 120.

The language preference detection manager 101 may then retrieve the language preference indicated in the user profile and cause the language preference settings of the receiving device 118 and/or the presentation 120 device to be set to the language preference of the user indicated in the retrieved user profile or otherwise control the receiving device 118 and/or the presentation 120 to cause media that is in the detected language to be electronically presented to the user via the presentation 120 device.

The optional language detection key 204, in some embodiments, activates the thumbprint scanner 206 specifically for identifying the user in order to determine a language preference of the user. When the user 220 pushes or otherwise activates the language detection key 204, the thumbprint enabled remote-control device 100 activates the thumbprint scanner 206 to initiate the language preference detection process, here performed by the language preference detection manager 101, as described herein. However, in other embodiments, there is no such language detection key 204 and the thumbprint enabled remote-control device 100 is in either a constant or a default state to receive or capture thumbprint data via the thumbprint scanner 206 and to perform the language preference detection process disclosed herein.

Furthermore, the language preference detection may be configured to operate in substantially real time. For example, if the language preference detection manager 101 receives thumbprint identification data by the thumbprint enabled remote-control device 100 and then the language preference detection manager 101 can immediately initiate language preference detection as soon as the thumbprint identification data is received, so that the language preference detection and presentation of media in the detected language can begin to operate automatically and immediately after the user places their thumb on the thumbprint scanner 206.

In an example embodiment, upon detecting the preferred language, the language preference detection manager 101 may initiate a receiving device command corresponding to the detected language. For example, if the detected language is Hindi, then the receiving device 118 may present media via the presentation device 120 that is in Hindi (e.g., a user interface, an EPG, a channel, a program, programming, a channel or program guide, channel or program suggestions, instructions, a help menu, a prompt, an audio track, and/or sub-titles, etc., that are in Hindi). With respect to visual media, it may be presented on display 124. In some embodiments, the receiving device 118 may cause the presentation device 120 to first prompt the user (e.g., with an audio and/or visual prompt in the detected language and also in a default language) to confirm the detected language preference is correct and whether to proceed with presenting media in the detected language preference.

In general, the language preference detection manager 101 can access any operational state or capability of the receiving device 118 based on the detected language preference. In various embodiments, the language preference detection manager 101 may provide access to only some subset of the capabilities of the receiving device 118, limited for example to those capabilities that are frequently used by typical users.

In the above example, the language preference detection manager 101 performed all or substantially all aspects of language preference detection upon data received from the thumbprint enabled remote-control device 100. In other embodiments, language preference detection may be performed in other ways or at other locations. For example, in one embodiment, the thumbprint enabled remote-control device 100 may include a language preference detector, such that substantially all language preference detection is performed at the thumbprint enabled remote-control device 100. In another embodiment, the performance of various language preference detection tasks is distributed between the thumbprint enabled remote-control device 100 and the language preference detection manager 101. For example, the thumbprint enabled remote-control device 100 may be configured to extract information about the thumbprint, and transmit that information to the language preference detection manager 101, where the information can be further processed to complete user identification and language preference detection.

In another embodiment, the language preference detection manager 101 may be controlled by biometric inputs received from a source other than the thumbprint enabled remote-control device 100. In particular, the language preference detection manager 101 may receive biometric data identifying the user from a user device, such as a smartphone or other mobile device. In some embodiments, the user device 122 includes the functionality and capabilities of the thumbprint enabled remote-control device 100.

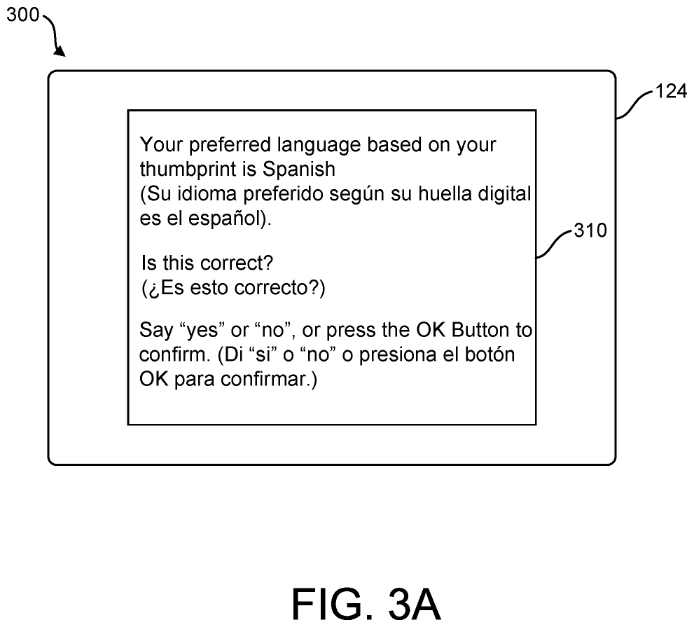

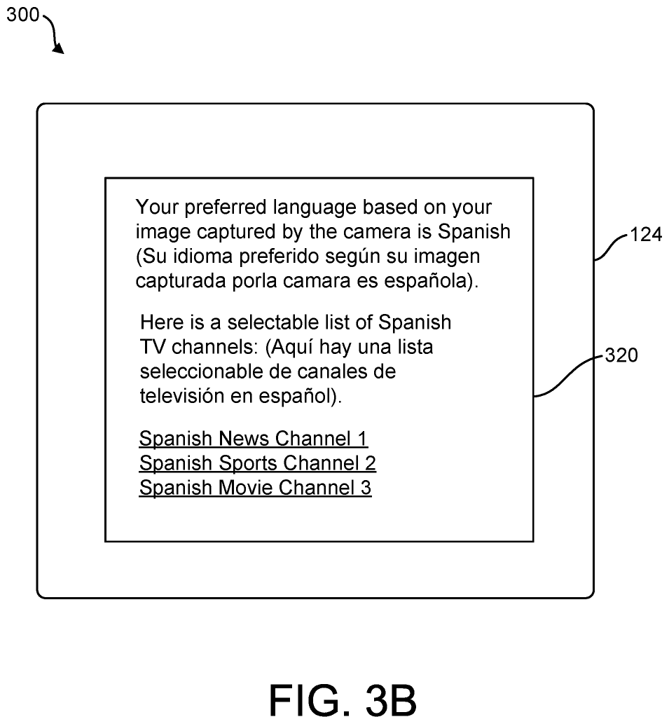

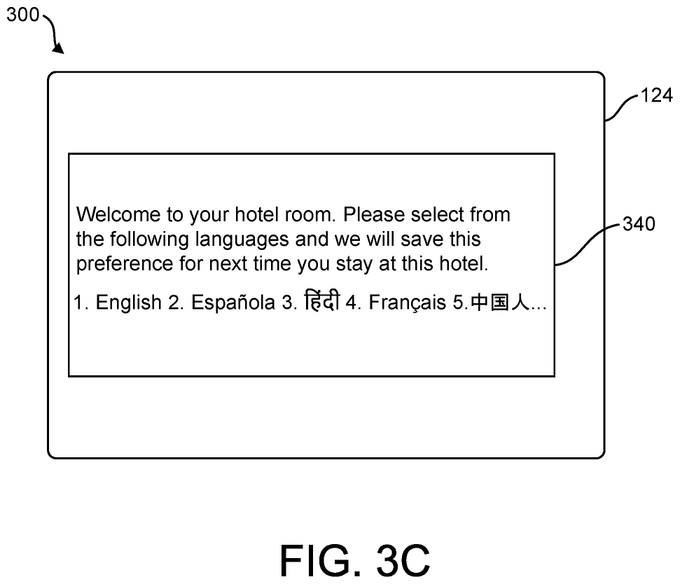

FIGS. 3A-3C are block diagrams illustrating example user interfaces provided by example embodiments. FIGS. 3A-3c illustrate various user interface elements provided by one or more example systems and methods for automatic detection of language preference in a media presentation system. In particular, FIGS. 3A-3C show a user interface 300 displayed upon a presentation device 120 coupled to a receiving device 118 having a language preference detection manager 101, such as is described with reference to FIG. 2. In these examples, the user interface 300 may be displaying a program or other content, along with additional elements that are presented in response to otherwise based on a detected language preference of the user.

In the example of FIG. 3A, the language preference of the user is detected by the receiving device 118 as Spanish (e.g., based on the user profile associated with the thumbprint indicating a language preference of Spanish). In response, a prompt 310 is presented on the display 124 in both the default language (e.g., English) and the detected language (in this case, Spanish) for the user to confirm that the detection of the language preference as being Spanish is correct. The user may then select “yes” or “no”, by selecting an “OK” button on the remote-control device, or speaking the words “yes” or “no” (in Spanish or English) in the case of using a voice enabled remote control device. If the user indicates that the detection of the language being spoken by the user as Spanish is correct, the receiving device 118 may then proceed to present additional media to the user in Spanish. If the user indicates that the detection of the language being spoken by the user as Spanish is incorrect, the receiving device 118 may continue to present media to the user 220 in the default language, or may ask the user for input via further prompts indicating what the preferred language is.

In the example of FIG. 3B, the system for automatic detection of language preference in a media presentation system has displayed a selectable list of channels 320 in the detected language on the display 124. For example, the selectable list of channels 320 in the detected language (e.g., Spanish) may be displayed in response to the detection of the language preference being Spanish. This language preference detection may be based on a user profile indicating Spanish as the preferred language being associated with an image captured of the user by a camera on receiving device 118, presentation device 120, user device 124 or remote control device 100. For example, the display of the selectable list of channels 320 in the detected language may occur without any intermediate or intervening operation or actions after the language preference is detected.

In other embodiments, the selectable list of channels 320 in the detected language (e.g., Spanish) may be displayed in response to the user confirming the detection of the language preference as being Spanish is correct, such as in response to the prompt 310 displayed in FIG. 3A. In yet other embodiments, the selectable list of channels 320 in the detected language (e.g., Spanish) may be displayed the next time the user selects an EPG to be displayed based on the detected language preference being Spanish. In some embodiments, the selectable list of channels 320 may be part of an EPG in which the channels in the detected language are displayed first before other channels that are not in the detected language.

In the example of FIG. 3C, the system for automatic detection of language preference in a media presentation system has displayed a prompt 340 on a television display 124 in a user's hotel room for the user to select their preferred language. For example, such a selection of language preference may be made via the remote control device in the hotel room that controls the presentation device on which the prompt 340 is displayed. This will not only cause the presentation device on which the prompt 340 is displayed to present media in the selected preferred language, but such selection will also be saved in a user profile accessible by a management system of the hotel (e.g., computerized management system 132 of FIG. 1). The user profile indicating the user's language preference may then be retrieved by the a management system each time the user checks in to the hotel or any other hotel operating a management system that can identify and has access to the user profile (e.g., over a computer network). For example, the user profile may be associated with the user's name, identification data (e.g. passport or driver license number), hotel or travel account user name, login credentials, thumbprint, other biometric data, etc. Thus, in some embodiments, the user need only place their thumb on the thumbprint scanner of the hotel room's remote control device and the television in that room will then automatically switch to presenting media in the preferred language indicated by the user's profile associated with their thumbprint.

In some embodiments, in response to the detecting the language preferred by the user is Spanish, the system electronically selects an audio track for a selected program that is in Spanish (e.g., for the sports program currently being displayed on display 124 and/or a future selected program). The receiving device 118 may then switch an audio track of a program of the selected program to the selected audio track that is in Spanish. In some embodiments, this switch may be automatically performed in response to the detection of the preferred language. In some embodiments, another notice may provide an option to switch back to the previous or default audio track of the program. Also, in some embodiments, a notice may first prompt the user for permission before switching the audio track to the detected language.

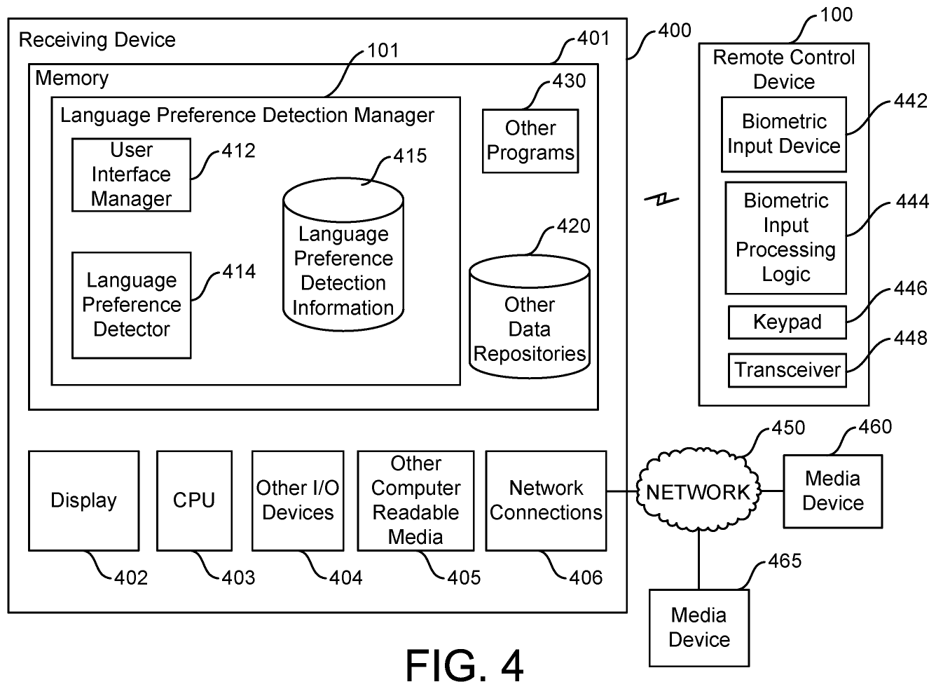

FIG. 4 is a block diagram of a computing system for practicing example embodiments of systems and methods for automatic detection of language preference in a media presentation system. As shown in FIG. 4, the described system for automatic detection of language preference in a media presentation system includes a thumbprint enabled remote-control device 100 and a receiving device computing system 400 having a language preference detection manager 101. In one embodiment, the receiving device computing system 400 is part of a set-top box configured to receive and display programming on a presentation device. Note that the computing system 400 may comprise one or more distinct computing systems/devices and may span distributed locations. Furthermore, each block shown may represent one or more such blocks as appropriate to a specific embodiment or may be combined with other blocks. Also, components of the system for automatic detection of language preference in a media presentation system, such as the language preference detection manager 101 and biometric input processing logic 444 may be implemented in software, hardware, firmware, or in some combination to achieve the capabilities described herein.

In the embodiment shown, receiving device computing system 400 comprises a computer memory (“memory”) 401, a display 402, one or more Central Processing Units (“CPU”) 403, Input/Output devices 404 (e.g., keyboard, mouse, LCD or touchscreen display, and the like), other computer-readable media 405, and network connections 406. The language preference detection manager 101 is shown residing in memory 401. In other embodiments, some portion of the contents, some of, or all of the components of the language preference detection manager 101 may be stored on and/or transmitted over the other computer-readable media 405. The components of the language preference detection manager 101 preferably execute on one or more CPUs 403 and facilitate language preference detection and control of the receiving device computing system 400 and/or other media devices, as described herein. Other code or programs 430 (e.g., an audio/video processing module, an electronic program guide manager module, a Web server, and the like) and potentially other data repositories, such as data repository 420 (e.g., including stored programming), also reside in the memory 410, and preferably execute on one or more CPUs 403. Of note, one or more of the components in FIG. 4 may not be present in any specific implementation. For example, some embodiments may not include a display 402, and instead utilize a display provided by another media device, such as a display 124 of presentation device 120.

The remote-control device 100 includes a biometric input device 442 (e.g., a thumbprint scanner), biometric input processing logic 444, a keypad 446, and a transceiver 448. In an example embodiment, the biometric input device 442 may include a scanner (e.g., with an optical sensor, capacitive sensor and/or ultrasonic sensor) which captures the pattern of ridges and valleys on a finger. The data representing pattern of ridges and valleys on a finger is then processed by the biometric input processing logic, which may compare it to a list of registered fingerprints on file to identify the user. Such identification information may then be transmitted to the language preference detection manager 101. As noted, various communication techniques are contemplated, including radio frequency (e.g., UHF), microwave, infrared, short range wireless (e.g., Bluetooth®) communication, or the like. The biometric input processing logic 444 may also receive input events generated by the keypad 446 and transmits those events, or commands corresponding to those events, to the language preference detection manager 101. The remote-control device 100 may include other components that are not illustrated here. For example, the thumbprint enabled remote-control device 100 may include a speaker to provide audio output to the user, such as audible beeps, voice prompts, etc.

In an example embodiment, the language preference detection manager 101 includes a user interface manager 412, a language preference detector 414, and a data repository 415 that includes language detection information (e.g., user profiles, indications of language preferences of various user profiles, databases of languages, grammars, translators, vocabularies, etc.). The language preference detection manager 101 is operable to electronically determine whether a particular user of a plurality of users is viewing or listening to a presentation device (e.g., based on the use identification data received from the biometric input device 442 and the biometric input processing logic 444) and then automatically detect which language of a plurality of languages is preferred by the particular user (e.g., based on a language4 preference indicated in a stored user profile of the identified user).

The language preference detection manager 101 also interacts via a network 450 with media devices 460-465. The network 450 may be include various type of communication systems, including wired or wireless networks, point-to-point connections (e.g., serial lines, media connection cables, etc.), and the like. Media devices 460-465 may include user devices (such as user device 122), video recorders, audio systems, presentation devices, home computing systems, and the like. The language preference detection manager 101 may also include a speech synthesizer configured to convert text into speech, so that the language preference detection manager 101 may provide audio output (e.g., spoken words) to a user in the detected preferred language. The audio output may be provided to the user in various ways, including via one or more speakers associated with one of the media devices 460-465 or the thumbprint enabled remote-control device 100.

The user interface manager 412 may perform some core functions of the language preference detection manager 101. In particular, the user interface manager 412 may receive biometric data from the thumbprint enabled remote-control device 100. The user interface manager 412 also receives events and/or commands from the thumbprint enabled remote-control device 100, such as indications of button selections on the keypad 446 and/or other signaling information transmitted by the thumbprint enabled remote-control device 100.

The user interface manager 412 may further control the operation of the receiving device computing system 400 based on the language detected provided by the language preference detector 414. For example, given a detected preferred language, the user interface manager 412 determines a command that corresponds to or is otherwise based on the particular detected preferred language. Then, the user interface manager 412 initiates or executes the determined command, such as by presenting media such as that shown in FIGS. 3A-3C, for example. The user interface manager 412 may in some cases confirm a detected preferred language and/or disambiguate multiple possible preferred languages that were detected.

The language detection information stored in repository 420 may also include audio files that include pre-recorded audio prompts or other messages in various applicable languages that may be played by the language preference detection manager 101 to interact with a user based on the particular language that is detected as being preferred.

In an example embodiment, components/modules of the language preference detection manager 101 and the biometric input processing logic 444 are implemented using one or more various programming techniques. For example, the biometric input processing logic 444 may also be implemented as a sequence of “native” instructions executing on a CPU (not shown) of the thumbprint enabled remote-control device 100. In addition, the language preference detection manager 101 may be implemented as a native executable running on the CPU 403, along with one or more static or dynamic libraries. In other embodiments, the language preference detection manager 101 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic. NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), declarative (e.g., SQL, Prolog, and the like).

The embodiments described above may also use synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported by a system for automatic detection of language preference in a media presentation system implementation. Also, other functions could be implemented and/or performed by each component/module, and in different orders, and by different components/modules, yet still achieve the functions of the system for automatic detection of language preference in a media presentation system.

In addition, programming interfaces to the data stored as part of the language preference detection manager 101, such as language preference detection information 415, can be available by standard mechanisms such as through C, C++, C#, and Java APIs; libraries for accessing files, databases, or other data repositories; through scripting languages such as XML; or through Web servers, FTP servers, or other types of servers providing access to stored data. The language preference detection information 415 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of a system for automatic detection of language preference in a media presentation system.

In particular, all or some of the language preference detection manager 101 and/or the biometric input processing logic 444 may be distributed amongst other components/devices. For example, the language preference detector 414 may be located on the thumbprint enabled remote-control device 100 or on some other system, such as a smartphone, mobile device, or remote server accessible via the network 450.

Furthermore, in some embodiments, some or all of the components of the language preference detection manager 101 and/or the biometric input processing logic 444 may be implemented or provided in other manners, such as at least partially in firmware and/or hardware, including, but not limited to one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

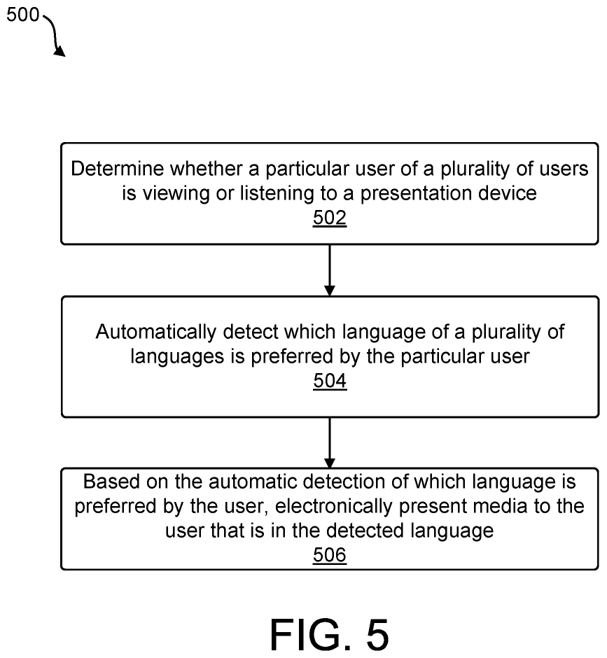

FIGS. 5-7 are flow diagrams of various processes provided by example embodiments. FIGS. 5-7 illustrate processes that may be implemented by, for example, one or more modules/components of the receiving device computing system 400 and/or the thumbprint enabled remote-control device 100, such as the language preference detection manager 101 and the biometric input processing logic 444, as described with respect to FIG. 4.

FIG. 5 is a flow diagram of a method 500 for presenting media based on automatic detection of which language is preferred, according to an example embodiment.

At 502, the method 500 electronically determines, by at least one computer processor, whether a particular user of a plurality of users is viewing or listening to a presentation device. In an example embodiment, the system receives biometric data identifying the user via a device (e.g., a remote control device, a camera, a tablet or smartphone associated with the user, etc.) coupled to the presentation device or coupled to a receiving device connected to the presentation device. In another example, a guest registration component of a computerized management system of a multi-unit property determines a particular unit of the multi-unit property that the user is staying in, wherein the particular unit is associated with the presentation device.

The biometric data may be data identifying the particular user based on a fingerprint of the user. In various example embodiments, the biometric data is data identifying the particular user based on one or more of: a voice pattern of the user, a voice signature of the user, voice recognition of the user; a hand shape of the user, a finger vein pattern of the user, iris characteristics of the user, retina characteristics of the user, facial recognition of the user, gestures of the user, gait of the user, movements of the user, and how the user moves a remote control device that is coupled to the presentation device or coupled to a receiving device connected to the presentation device. In an example embodiment, the biometric data is data identifying the particular user based on a voice recognition of the user. In such embodiments, the biometric data identifying the particular user may include data representing spoken words of the user and is additionally used in the automatically detecting which language of a plurality of languages is preferred by the particular user.

At 504, the method 500 automatically detects, by at least one computer processor, which language of a plurality of languages is preferred by the particular user in response to the electronic determination whether the particular user is viewing or listening to the presentation device. For example, a computerized management system electronically retrieving from a database a preference setting previously set for the user. In an example embodiment, in response to the computerized management system electronically retrieving from a database a preference setting previously set for the user, the computerized management system electronically causes the presentation device to electronically present media to the user in the detected language.

At 506, the method 500, based on the automatic detection of which language of a plurality of languages is preferred by the user, electronically presents, by at least one computer processor, media to the user that is in the detected language. For example, this may include one or more of: automatically selecting language preference settings available in a configuration menu of the presentation device or receiving device connected to the presentation device based on the detected language; automatically switching to a user interface on the presentation device that is in the detected language; automatically switching to an audio track of a program being displayed on the presentation device that is in the detected language; automatically switching to present on the presentation device audio captions that are in the detected language for a program currently being displayed on the presentation device; automatically presenting on the presentation device a selectable list that only includes one or more television channels that is in the detected language or other content that is in the detected language; automatically presenting on the presentation device a selectable list of recommendations of content that is in the detected language; and automatically selecting and presenting on the presentation device content of one or more television channels that are in the detected language.

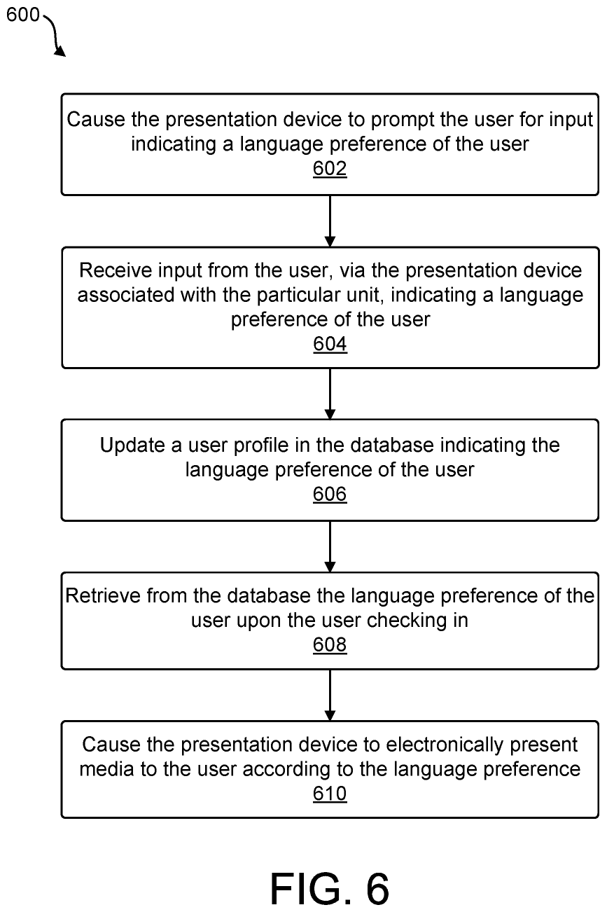

FIG. 6 is a flow diagram of a method 600 for presenting media based on a language preference saved in a database accessible by a computerized management system of a multi-unit property, according to an example embodiment.

At 602, the computerized management system electronically causes the presentation device to prompt the user for input indicating a language preference of the user.

At 604, in response to the prompt, the computerized management system electronically receiving input from the user, via the presentation device associated with the particular unit, indicating a language preference of the user.

At 606, the computerized management system electronically updates a user profile in the database indicating the language preference of the user;

At 608, the computerized management system electronically retrieves from the database the language preference of the user upon the user checking in via the a guest registration component.

At 610, in response to the computerized management system retrieving from the database the language preference of the user upon the user checking in via the a guest registration component, the computerized management system electronically causes the presentation device to electronically present media to the user according to the language preference.

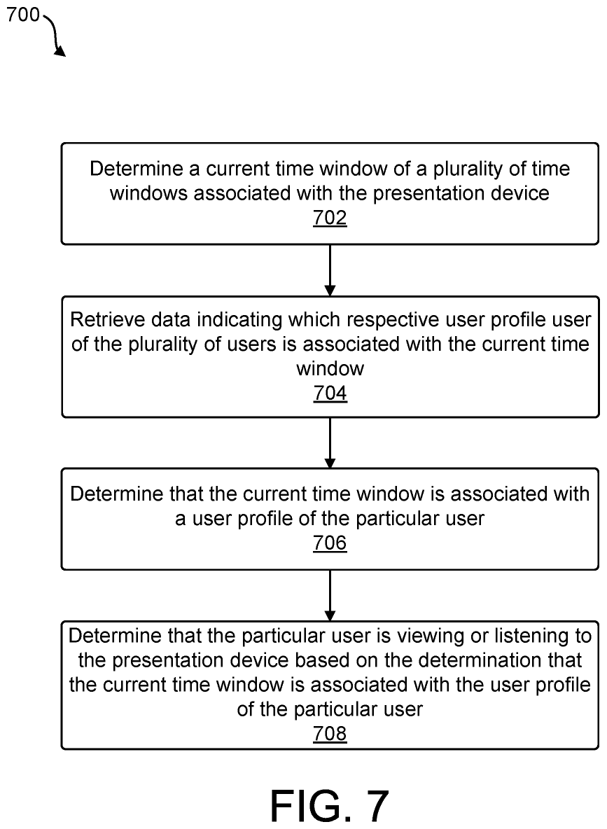

FIG. 7 is a flow diagram of a method 700 for determining that a particular user having a particular language preference is viewing or listening to the presentation device based on time windows.

At 702, the method 700 electronically determines a current time window of a plurality of time windows associated with the presentation device, wherein each time window of the plurality of time windows is associated with a respective user profile of a user of the plurality of users.

At 704, the method 700 electronically retrieves data indicating which respective user profile user of the plurality of users is associated with the current time window.

At 706, the method 700 electronically determines that the current time window is associated with a user profile of the particular user.

At 708, the method 700 electronically determines that the particular user of a plurality of users is viewing or listening to the presentation device based on the determination that the current time window is associated with the user profile of the particular user. The method 700 may then automatically detect which language of a plurality of languages is preferred by the particular user based on, in response to electronically determining that the particular user of a plurality of users is viewing or listening to the presentation device, electronically retrieving data from the user profile of the particular user indicating a language preference of the particular user.

While various embodiments have been described hereinabove, it is to be appreciated that various changes in form and detail may be made without departing from the spirit and scope of the invention(s) presently or hereafter claimed.

1. A method comprising:
electronically determining, by at least one computer processor, whether a particular user of a plurality of users is viewing or listening to a presentation device;
automatically detecting, by at least one computer processor, which language of a plurality of languages is preferred by the particular user in response to the electronic determination whether the particular user is viewing or listening to the presentation device; and
based on the automatic detection of which language of a plurality of languages is preferred by the user, electronically presenting, by at least one computer processor, media to the user that is in the detected language.

2. The method of claim 1 wherein the electronically determining whether a particular user of a plurality of users is viewing or listening to a presentation device includes:
receiving biometric data identifying the user via a device coupled to the presentation device or coupled to a receiving device connected to the presentation device.

3. The method of claim 2 wherein the device is a remote control device.

4. The method of claim 2 wherein the device includes a camera for identifying the user.

5. The method of claim 4 wherein the remote control device is a tablet or smartphone associated with the user.

6. The method of claim 2 wherein the biometric data is data identifying the particular user based on a fingerprint of the user.

7. The method of claim 2 wherein the biometric data is data identifying the particular user based on one or more of: a voice pattern of the user, a voice signature of the user, voice recognition of the user; a hand shape of the user, a finger vein pattern of the user, iris characteristics of the user, retina characteristics of the user, facial recognition of the user, gestures of the user, gait of the user, movements of the user, and how the user moves a remote control device that is coupled to the presentation device or coupled to a receiving device connected to the presentation device.

8. The method of claim 7 wherein the biometric data is data identifying the particular user based on a voice recognition of the user and wherein the biometric data identifying the particular user includes data representing spoken words of the user and is additionally used in the automatically detecting which language of a plurality of languages is preferred by the particular user.

9. The method of claim 1 wherein the electronically determining whether a particular user of a plurality of users is viewing or listening to a presentation device includes:
a guest registration component of a computerized management system of a multi-unit property determining a particular unit of the multi-unit property that the user is staying in, wherein the particular unit is associated with the presentation device.

10. The method of claim 9 wherein the automatically detecting which language of a plurality of languages is preferred by the particular user includes:
the computerized management system electronically retrieving from a database a preference setting previously set for the user.

11. The method of claim 10 wherein the electronically presenting media to the user that is in the detected language includes:
in response to the computerized management system electronically retrieving from a database a preference setting previously set for the user, the computerized management system electronically causing the presentation device to electronically present media to the user in the detected language.

12. The method of claim 11, further comprising:
the computerized management system electronically causing the presentation device to prompt the user for input indicating a language preference of the user;
in response to the prompt, the computerized management system electronically receiving input from the user, via the presentation device associated with the particular unit, indicating a language preference of the user;
the computerized management system electronically updating a user profile in the database indicating the language preference of the user;
the computerized management system electronically retrieving from the database the language preference of the user upon the user checking in via the a guest registration component; and
in response to the computerized management system retrieving from the database the language preference of the user upon the user checking in via the a guest registration component, the computerized management system electronically causing the presentation device to electronically present media to the user according to the language preference.

13. The method of claim 1 wherein the electronically determining whether a particular user of a plurality of users is viewing or listening to a presentation device includes:
electronically determining a current time window of a plurality of time windows associated with the presentation device, wherein each time window of the plurality of time windows is associated with a respective user profile of a user of the plurality of users;
electronically retrieving data indicating which respective user profile user of the plurality of users is associated with the current time window;
electronically determining that the current time window is associated with a user profile of the particular user; and
electronically determining that the particular user of a plurality of users is viewing or listening to the presentation device based on the determination that the current time window is associated with the user profile of the particular user.

14. The method of claim 13 wherein the automatically detecting which language of a plurality of languages is preferred by the particular user includes:
in response to electronically determining that the particular user of a plurality of users is viewing or listening to the presentation device, electronically retrieving data from the user profile of the particular user indicating a language preference of the particular user.

15. The method of claim 1 wherein the electronically presenting media to the user that is in the detected language includes one or more of:
automatically selecting language preference settings available in a configuration menu of the presentation device or receiving device connected to the presentation device based on the detected language;
automatically switching to a user interface on the presentation device that is in the detected language;
automatically switching to an audio track of a program being displayed on the presentation device that is in the detected language;
automatically switching to present on the presentation device audio captions that are in the detected language for a program currently being displayed on the presentation device;
automatically presenting on the presentation device a selectable list that only includes one or more television channels that are in the detected language or other content that is in the detected language;
automatically presenting on the presentation device a selectable list of recommendations of content that is in the detected language; and
automatically selecting and presenting on the presentation device content of one or more television channels that are in the detected language.

16. A system comprising:
at least one computer processor; and
at least one memory coupled to the at least one computer processor, wherein the at least one memory has computer-executable instructions stored thereon which, when executed by the at least one computer processor, cause operations to be performed, the operations including:
electronically determining, by at least one computer processor, whether a particular user of a plurality of users is viewing or listening to a presentation device;
automatically detecting, by at least one computer processor, which language of a plurality of languages is preferred by the particular user in response to the electronic determination whether the particular user is viewing or listening to the presentation device; and
based on the automatic detection of which language of a plurality of languages is preferred by the user, electronically presenting, by at least one computer processor, media to the user that is in the detected language.

17. The system of claim 16 wherein the electronically determining whether a particular user of a plurality of users is viewing or listening to a presentation device includes:
receiving biometric data identifying the user via a device coupled to the presentation device or coupled to a receiving device connected to the presentation device.

18. The system of claim 17 wherein the device is a remote control device.

19. A non-transitory computer-readable storage medium having computer-executable instructions stored thereon which, when executed by at least one computer processor, cause operations to be performed, the operations including:
electronically determining, by at least one computer processor, whether a particular user of a plurality of users is viewing or listening to a presentation device;
automatically detecting, by at least one computer processor, which language of a plurality of languages is preferred by the particular user in response to the electronic determination whether the particular user is viewing or listening to the presentation device; and
based on the automatic detection of which language of a plurality of languages is preferred by the user, electronically presenting, by at least one computer processor, media to the user that is in the detected language.

20. The non-transitory computer-readable storage medium of claim 19 wherein the electronically determining whether a particular user of a plurality of users is viewing or listening to a presentation device includes:
receiving biometric data identifying the user via a device coupled to the presentation device or coupled to a receiving device connected to the presentation device.
